(19) United States
(12) Patent Application Publication
(10) Pub. No.: US 2023/0316371 A1
(43) Pub. Date: Oct. 5, 2023

(54) GENERATING PRODUCT RECOMMENDATIONS USING STACKED MACHINE LEARNING MODELS

(71) Applicant: INTERNATIONAL BUSINESS MACHINES CORPORATION, ARMONK, NY (US)

(72) Inventors: Stephen Carrow, Jersey City, NJ (US); Howard Zhang, New York, NY (US); Mengxi Lv, Redwood City, CA (US); Kashyap Nagaraja, White Plains, NY (US); Anushree B Mehta, White Plains, NY (US); Aleksandra Hosa, Long Island City, NY (US); John Jenkins, Freeport, FL (US)

(21) Appl. No.: 17/656,966

(22) Filed: Mar. 29, 2022

(51) Int. Cl. G06Q 30/06; G06N 5/02

(52) U.S. Cl. CPC G06Q 30/0631; G06N 5/022

(57) ABSTRACT

A method, computer system, and a computer program for generating recommendations using stacked models is provided. The present invention may include receiving a first dataset pertaining to a territory plan associated with a user and a second dataset pertaining to prospective-based data. The present invention may then include detecting a plurality of target variables associated with the B2B party within the first and second datasets. The present invention may further include determining a convergence of at least two target variables of the plurality of target variables. The present invention may further include generating a product recommendation associated with the B2B party based on the convergence.

### BACKGROUND

The present invention relates generally to artificial intelligence, and more particularly, to utilizing stacked machine learning models for generating recommendations.

Common issues within the business-to-business (B2B) industry include the extensive amount of time needed to prospect clients both from a digital standpoint and a field standpoint. For example, developing territory plans based on data pertaining to business entities within the territory for parties in the digital realm requires the most amount of time during digital prospecting, and interpreting historical pipeline activity, firmographics, and other applicable data pertaining to clients in the field requires an extensive amount of time and resources. In addition, the needs/demands of a client and the products/services configured to fulfill said needs/demands are not correlated because the aforementioned data for each respective demand and product are two separate data types.

### SUMMARY

Additional aspects and/or advantages will be set forth in part in the description which follows and, in part, will be apparent from the description, or may be learned by practice of the invention.

According to one exemplary embodiment, a computer-implemented method for generating recommendations using stacked models is provided. A computer receives a first dataset pertaining to a territory plan associated with a user and a second dataset pertaining to prospective-based data. The computer detects a plurality of target variables associated with the B2B party within the first and second datasets. The computer determines a convergence of at least two target variables of the plurality of target variables. The computer further generates a product recommendation associated with the B2B party based on the convergence.

With this embodiment, the computer detecting the plurality of target variables includes generating, via a first machine learned model trained based on the first dataset, a first machine learning model output pertaining to a demand associated with the B2B party; and generating, via a second machine learned model trained based on the second dataset, a second machine learning model output pertaining to a product or service associated with the demand.

With this embodiment, the computer determining the convergence includes acquiring a plurality of supplemental data; merging the first machine learned model and the second machine learned model into a stacked model based on at least the plurality of supplemental data; and inserting the first and second outputs into the stacked model. In some embodiments, the computer determining the convergence may also include mapping the two target variables of the plurality of target variables based on the merger; and generating the recommendation in which the recommendation is an output of the stacked model.

According to another exemplary embodiment, a computer system for automatically generating product recommendations is provided. The computer system includes one or more processors, one or more computer-readable memories, and program instructions stored on at least one of the one or more computer-readable memories for execution by at least one of the one or more processors to cause the computer system to: program instructions to receive a first dataset pertaining to a territory plan associated with a user and a second dataset pertaining to prospective-based data; program instructions to detect a plurality of target variables associated with the B2B party within the first and second datasets; program instructions to determine a convergence of at least two target variables of the plurality of target variables; and program instructions to generate a product recommendation associated with the B2B party based on the convergence.

A computer program product using a computing device for automatically generating product recommendations, the computer program product including one or more non-transitory computer-readable storage media and program instructions stored on the one or more non-transitory computer-readable storage media, the program instructions, when executed by the computing device, cause the computing device to perform a method comprising: receiving, via a computing device, a first dataset pertaining to a territory plan associated with a user and a second dataset pertaining to prospective-based data; detecting, via the computing device, a plurality of target variables associated with the B2B party within the first and second datasets; determining, via the computing device, a convergence of at least two target variables of the plurality of target variables; and generating, via the computing device, a product recommendation associated with the B2B party based on the convergence.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a functional block diagram illustrating a computational environment for generating product recommendations according to at least one embodiment;

FIG. 2 illustrates a block diagram of exemplary network resources of the environment of FIG. 1 according to at least one embodiment;

FIGS. 3A-B illustrates a functional block diagram illustrating generation of a stacked model for generating product recommendations according to at least one embodiment;

FIG. 4 illustrates a flowchart illustrating a process for generating a product recommendation according to at least one embodiment;

FIG. 5 illustrates an exemplary user interface of implementations of embodiments of the invention according to at least one embodiment;

FIG. 6 depicts a block diagram illustrating components of the software application of FIG. 1, in accordance with an embodiment of the invention; and

FIG. 7 depicts a cloud-computing environment, in accordance with an embodiment of the present invention

FIG. 8 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for generating product/service recommendations. B2B sellers may be tasked with gathering data from various sources in order to ascertain not only whether a prospect is a qualified lead, but also if the needs/demands of the prospect align with available products and/or services. A major issue associated with this data gathering process is not only that it accounts for about 40% of the overall prospecting process, but also the data necessary to efficiently prospect is continuously accumulating and changing rendering the prospecting process significantly more time-consuming and difficult. In addition, although products and services may be configured to align with a prospect's demand/need, there is a lack of correlation between the demand/need and aligning products/services due to the massive amount of factors and data that may be relevant during the data gathering stage including but not limited to install bases, historical pipeline activities, firmographics, marketing engagement, digital footprints, etc. Moreover, once all of this data is gathered it must still be processed and analyzed in order to ascertain which product/service is applicable and who is the appropriate party authorized to make the decision to purchase the product/service. Computation of the aforementioned gathered data presents a hurdle in environments, such as learning systems, due to the fact that the data sources are of inconsistent types resulting in an inability to combine multiple machine learned models due to their inconsistent data types, inherent target variables, and inherent algorithms. As such, the present embodiments have the capacity to improve the field of B2B transactions and computing overall via a system and method to combine models derived from disparate data sources in order to generate recommendations for parties of B2B transactions.

As described herein, a prospect is a customer, potential customer, business client, lead, contact, or any other applicable individual (e.g., of an entity) and/or entity configured to be a party to a B2B transaction known to those of ordinary skill in the art.

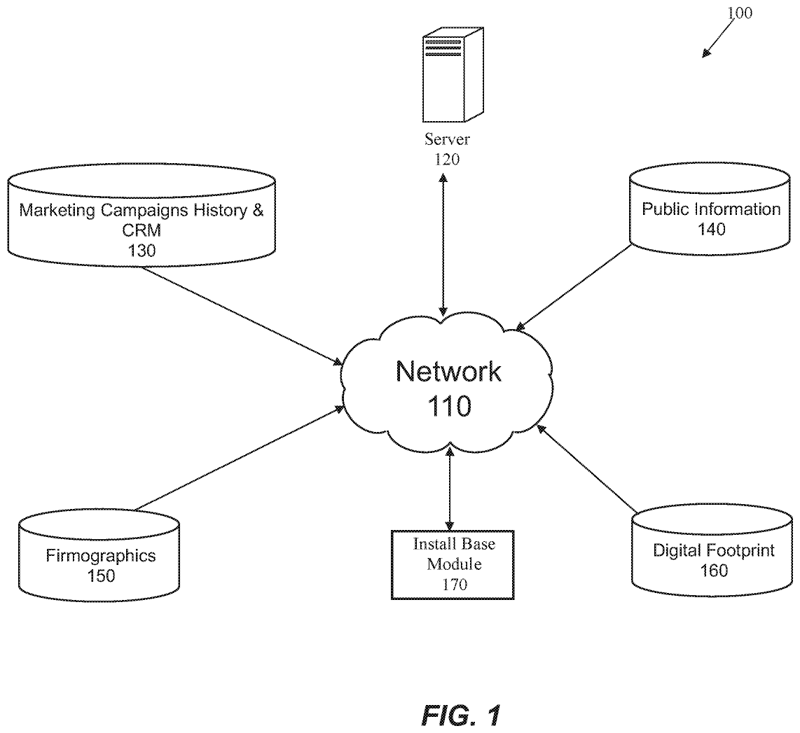

Referring to FIG. 1, a product/service recommendation computing environment 100 is depicted, according to an exemplary embodiment. FIG. 1 provides only an illustration of implementation and does not imply any limitations regarding the environments in which different embodiments may be implemented. Modifications to environment 100 may be made by those skilled in the art without departing from the scope of the invention as recited by the claims. In some embodiments, environment 100 includes a server 120, a marketing campaigns history and customer relationship management system 130 (CRM), a public information database 140, a firmographics database 150, an install base module 170, and a digital footprint database 160 in which each the aforementioned systems and/or databases are communicatively coupled to server 120 over network 110. Network 110 may include various types of communication networks, such as a wide area network (WAN), local area network (LAN), a telecommunication network, a wireless network, a public switched network and/or a satellite network, etc. In some embodiments, network 110 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. In some embodiments, network 110 is configured as public cloud computing environments, which can be providers known as public cloud services providers, e.g., IBM® CLOUD® cloud services, AMAZON® WEB SERVICES® (AWS®), or MICROSOFT® AZURE® cloud services. (IBM® and IBM CLOUD are registered trademarks of International Business Machines Corporation. AMAZON®, AMAZON WEB SERVICES® and AWS® are registered trademarks of Amazon.com, Inc. MICROSOFT® and AZURE® are registered trademarks of Microsoft Corporation.) Embodiments herein can be described with reference to differentiated fictitious public computing environment (cloud) providers such as ABC-CLOUD, ACME-CLOUD, MAGIC-CLOUD, and SUPERCONTAINER-CLOUD. It should be appreciated that FIG. 1 provides only an illustration of one implementation and does not imply any limitations with regard to the environments in which different embodiments may be implemented. Many modifications to the depicted environments may be made based on design and implementation requirements.

It should be noted that server 120 is configured to generate a centralized platform designed to be presented on a computing device (not shown) of a user associated with a prospect (e.g., the selling party in a B2B transaction), in which the centralized platform is configured to transmit recommendations associated with a product/service configured to fulfill the needs/demands of the prospect (e.g., the buying party in the B2B transaction). The computing device may include one or more of a wearable device, a mobile device, a telephone, a personal digital assistant, a netbook, a laptop computer, a tablet computer, a desktop computer, or any applicable type of computing devices capable of running a program, accessing a network, and/or accessing one or more databases. In some embodiments, CRM 130 includes data not generally available to the public including but not limited to identity data (e.g. prospect name, mailing address, contact information, social media, etc.), descriptive data (e.g., career/education, family details, lifestyle information etc.), quantitative data (e.g., purchase history, website analytics, internet engagement, service tickets filed, etc.), qualitative data (e.g., historical data on marketing campaigns, buyer sentiment analytics, etc.), or any other applicable data inherent of CRM systems known to those of ordinary skill in the art. In some embodiments, public information database 140 includes a company name, revenue, company size, industry, number of employees, annual reports, brands, growth, historical sales, and any other applicable public data pertaining to the prospect. In some embodiments, firmographics database 150 includes any type of data that can be used to categorize organizations including but not limited to geographic area, number of clients, applicable industries, technologies utilized-applicable hardware/software, type of organization, or any other applicable firmographic/technographic data known to those of ordinary skill in the art. Firmographics database 150 may also include confidential data (e.g., business strategies, trade secrets, in-house data, etc.) specific to the prospect. In some embodiments, digital footprint database 160 includes but is not limited to media uploads, website modifications, social media posts, internet analytics, or any other applicable data pertaining to the traceable digital activities, actions, contributions and communications that are manifested on the Internet or on computing devices known to those of ordinary skill in the art. In some embodiments, install base module 170 is a centralized database including a product/service instance and its tracking details including location, status, ownership, party role, and contact relationships. Install base module 170 may be specific to the prospect and may also include functionality to create and/or maintain install base configurations. It should be noted that although the aforementioned systems and data sources are configured to continuously transmit applicable data to server 120 over network 110, server 120 may also be communicatively coupled to one or more web crawlers or applicable third-party servers/systems configured to continuously contribute content to the aforementioned systems/data sources allowing server 120 to process and optimize data necessary for the ultimate generation of recommendations for the prospect. For example, the one or more web crawlers may continuously search, locate, and ascertain data such as news article content, mentions of the prospect, financial information, or any other applicable data configured to be ascertained from the internet by web crawlers and store the acquired data within public information database 140. Third party systems may also include secretary of state information regarding an incorporated prospect, other state provided information regarding the prospect such as property values, mapping systems that depict a location and other applicable data about the prospect, and internet-based interactions of the prospect by prospect's customers, suppliers and other persons or entities that interact with the prospect.

It should be noted that due to the volumes of data from various sources, the aforementioned data is considered disparate in that it may be disintegrated and/or not subject oriented. The invention provided herein is configured to utilize models and/or rules for the disparate data sources and data types in order to align available product/services with the needs/demands of the prospect. In particular, the collection, detection, and filtering of data from the aforementioned data sources proves to be one of the most time-consuming processes of B2B transactions, which is automated and reduced by the practices disclosed herein.

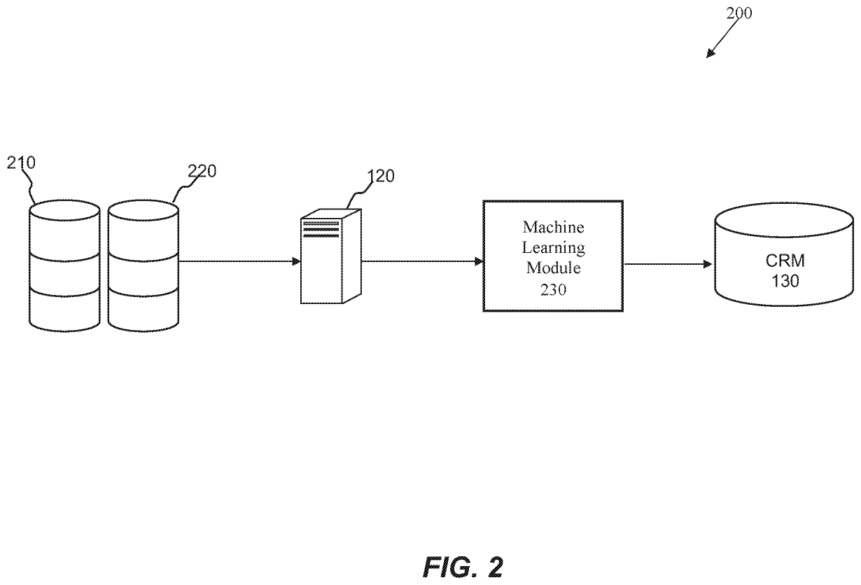

Referring now to FIG. 2, a schematic illustration of exemplary network resources 200 associated with practicing the disclosed inventions is depicted. The inventions may be practiced in the processors of any of the disclosed elements which process an instruction stream; however, in a preferred embodiment, network resources 200 includes a machine learning module 230 configured to receive data from server 120 acquired from the aforementioned data sources. In some embodiments, one or more relevant features and/or characteristics relating to the target variables may be ascertained by server 120, and machine learning module 230 may be configured to map the features and/or characteristics to the target variables. In some embodiments, server 120 may ascertain flows between parties of B2B transactions in which the flows may be quantitative values, intensity scores, or intensity categories between pairs or tuples of entities. Server 120 may also be configured to utilize data derived from any of the aforementioned data sources in addition to outputs of the machine learned models described herein in order to ascertain the particular person of contact associated with the prospect who should be engaged in order to facility the particular B2B transaction.

As depicted herein, a first dataset 210 and a second dataset 220 are reflective of disparate data sources including data derived from one or more of the aforementioned data sources of FIG. 1. For the purpose of the disclosure, it is imperative that server 120 receives datasets 210 and 220 as separate and distinct datasets due to the fact that machine learning module 230 is configured to generate respective machine learning models based on training sets derived from the respective datasets. For example, first dataset 210 may pertain to technographic information derived from firmographics database 150 relevant to the prospect that describes the hardware and/or software the prospect may utilize to operate its business, and second dataset 220 may include news content derived from public information database 140 pertaining to a new trend in the technology that is useful within the industry that prospect is within. Server 120 may ascertain that datasets 210 and 220 are disparate; thus, instructing machine learning module 230 to begin the training phase in which a first training set is generated for first dataset 210 and a second training set is generated for second dataset 220. In some embodiments, first dataset 210 includes a plurality of intent indicators which includes but is not limited to indicators of accounts who are actively searching products/services associated with the user, and second dataset 220 includes previous, current, and/or prospective goods/services. Machine learning module 230 generates a first machine learning model based on the first training set and a second machine learning model is generated based on the second training set. The first machine learning model is configured to generate an output reflecting a predicted need/demand associated with the prospect and the second machine learning model is configured to generate an output reflecting a predicted product configured to solve, remedy, and/or address the need/demand. It should be noted that server 120, with the assistance of machine learning module 230, is configured to detect a plurality of target variables within datasets 210 and 220 in which the plurality of target variables are variables whose values are to be modeled and predicted by other variables. In particular, the plurality of target variables may be derived from one or more interactions of the party interacting with the prospective including but not limited to an entity acting on the generated recommendation, indicators of whether an opportunity was created, indicators of whether a sale was completed, or any other ascertainable target variables know to those of ordinary skill in the art. For example, the plurality of target variables may be derived from intent of the prospect to purchase a product/service, an ascertainable need/demand associated with the prospect, pain points associated with the prospect.

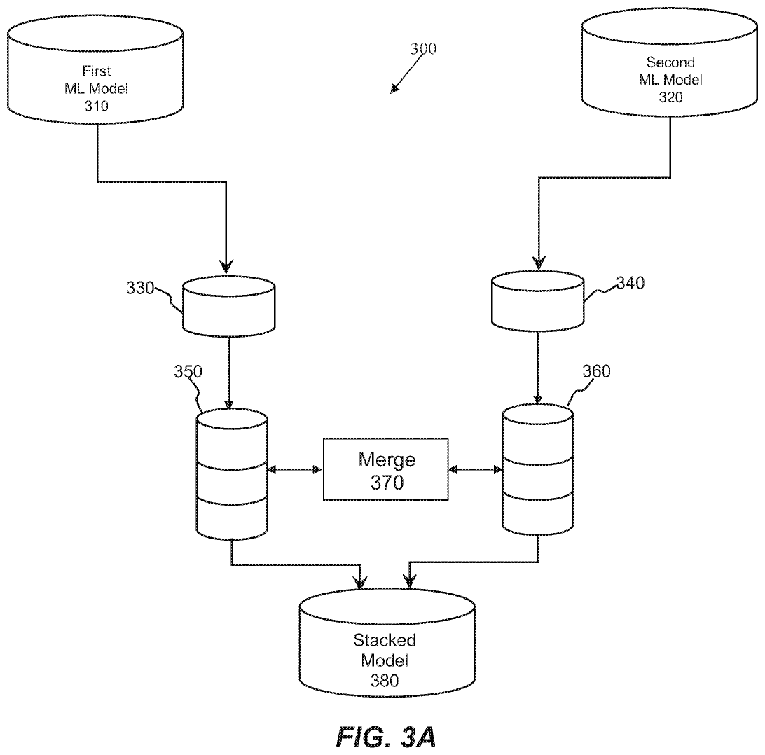

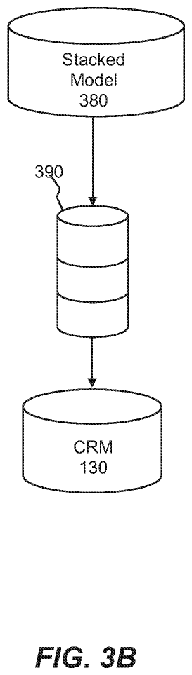

Referring now to FIGS. 3A-B, a diagram 300 illustrating the stages of generating a recommendation for the prospect is depicted in accordance with an exemplary embodiment. It should be noted that the purpose of diagram 300 is to depict not only the generation of the recommendation but also the utilization of a third machine learning model to perform mapping of the outputs of the first and second machine learning models, and utilizing a stacked model to generate a recommendation for the prospect. In some embodiments, a first machine learned model 310 and a second machine learned model 320 generate a plurality of outputs in which the outputs of the respective models are based on disparate data derived from dataset 210 and 220. It should be noted that first machine learned model 310 and second machine learned model 320 have no correlation, in which the utilization of target variables and the facilitation of data derived from supplemental databases 330 and 340 is necessary in order to provide data derived from one or more of the aforementioned data sources of FIG. 1 and/or an applicable third party. It should be noted that supplemental databases 330 and 340 may be manually curated datasets, applicable content derived from webpages, or any applicable data source known to those of ordinary skill in the art. The purpose of supplemental databases 330 and 340 is to provide additional data for target variable purposes along with assist processing by a first deep learning model 350 and a second deep learning model 360 (e.g., mapping the target variables) in which deep learning models 350 and 360 serve the purpose of generating mappings of the respective outputs of machine learned models 310 and 320 based on the one or more target variables. In some embodiments, the mapping of the outputs is performed based on the plurality of target variables allowing the mapping to be specific to the relationship pertaining to the plurality of target variables (e.g., an intersection of two target variables); however, outputs of any of the models disclosed herein may be compared to each other in order for server 120 to ascertain a similarity threshold score in which the similarity threshold score may be assigned to an applicable product/service or demand/need. In some embodiments, deep learning models 350 and 360 are configured to utilize a merging function 370 in order to generate one or more outputs based upon the mappings. For example, the output of first machine learned model 310 may pertain to a predicted product/service need associated with the prospect and the output of second machine learned model 320 may pertain to a predicted product/service available. Traditionally, there is no correlation between the various outputs due mostly to the datasets being disparate sources; however, deep learning models 350 and 360, via utilizing the respective outputs in addition to data derived from supplemental databases 330 and 340 (e.g., webpage content regarding trends associated with the applicable product/service and/or industry), generates one or more mappings associated with the respective outputs based on the merger (e.g., convergence of target variables). In some embodiments, deep learning models 350 and 360 are Rosetta Stone models configured to support merging function 370 which are designed to output aligned explanations of predictions based on the plurality of target variables. The mapping functionality is configured to map relations among the target variables at both the data layer and the output layer of the applicable models.

Continuing the previous example, the output of deep learning machine learned model 350 is topics that assist explanation of the predicted need/demand derived from the output of first machine learned model 310 and the output of deep learning machine learned model 360 is recent purchases that assist explanation of the next purchase prediction derived from the output of second machine learned model 320. Deep learning machine learned models 350 and 360 utilize merging function 370 with assistance from the one or more generated mappings to generate an output representing an aligned explanation of predictions based on the plurality of target variables. The generated mappings are essentially mappings of the plurality of target variables to each other; thus, unconventionally creating correlations between data from disparate sources.

It should be noted that merging function 370 performed by deep learning machine learned models 350 and 360 is novel due to the fact that other methods of combining machine learning models (e.g., bagging and stacking) are not configured to support combinations of models that are derived from disparate data sources. However, the aforementioned mapping and merging functions may be performed by models other than machine learning models, such as rule-based. In some embodiments, machine learning module 230 is designed and configured to circumvent the issue of disparate data sources by utilizing models to map the plurality of target variables to each other allowing the ability to combine models, such as machine learned models 310 and 320. In some embodiments, the resulting output of deep learning machine learned models 350 and 360 post merger is configured to be inserted into a stacked model 380. Stacked model 380 is configured to generate a recommendation output 390 in which the recommendation output 390 is a prediction generated based off the outputs of deep learning machine learned models 350 and 360 integrating data derived from supplemental databases 330 and 340 and the generated mappings. In some embodiments, recommendation output 390 is derived based on the aforementioned in addition to a determination of server 120 of a convergence of at least two target variables of the plurality of target variables. An example of recommendation output 390 is an aligned tuple of model predictions that are not required to be inherently aligned. In some embodiments, recommendation output 390 is configured to be presented in an intuitive natural language and reflect not only predictions of the target variables, but also provide automated surfacing model explanations. In some embodiments, recommendation output 390 may be presented as tabular data configured to be filtered, sorted, etc. It should be noted that visualizations of recommendation output 390 may be manifested as topics of interest bubbles associated with the prospect, data maps, graphs, charts, or any other applicable form of representing data known to those of ordinary skill in the art. In some embodiments, recommendation output 390 is a predicted likelihood that the prospect will purchase a product/service from the user. Recommendation output 390 may be configured to be presented to the user on the centralized platform hosted by server 120 or transmitted for presentation or analysis on CRM 130.

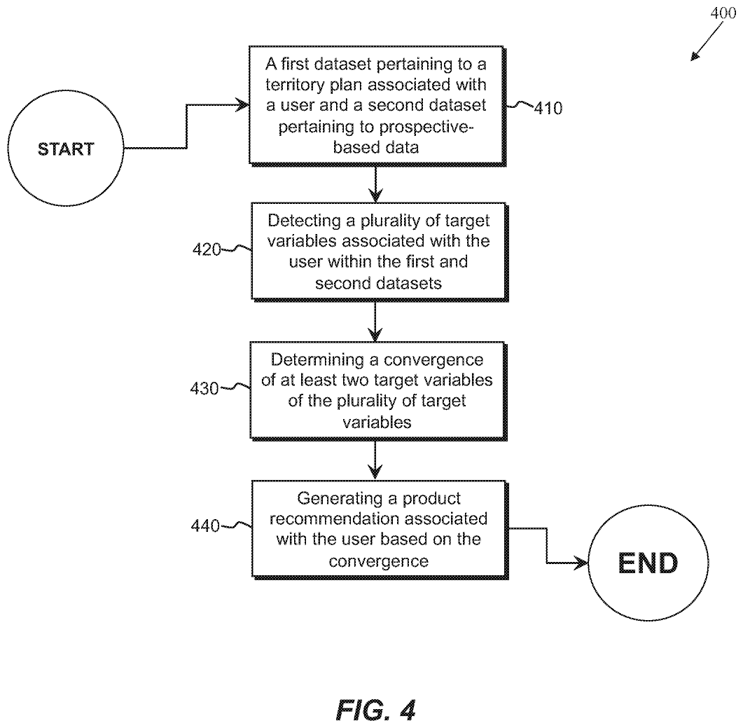

Referring now to FIG. 4, an operational flowchart illustrating an exemplary process for generating product/service recommendations 400 is depicted according to at least one embodiment.

At step 410 of process 400, server 120 receives first dataset 210 and second dataset 220 in which datasets 210 and 220 are derived from one or more of CRM 130, public information database 140, firmographics database 150, install base module 170, and/or digital footprint database 160. In a preferred embodiment, first dataset 210 includes data associated with a territory plan of the user and second dataset 220 includes data associated with prospective based data in which the territory plan pertains to a seller blueprint for the user and prospective-based data is any applicable prospect data both of which may be sourced from one or more of CRM 130, public information database 140, firmographics database 150, install base module 170, and/or digital footprint database 160 such as further discusses in connection with FIG. 1. It should be noted that components and/or sub-components of databases 130-170 may be referred to as prospective-data and the territory plan may be a derivative of prospective-data and/or any applicable data pertaining to a B2B party.

At step 420 of process 400, server 120 detects the plurality of target variables within datasets 210 and 220. It should be noted that server 120, via assistance from machine learning module 230, is configured to continuously identify the target variables for the purpose of optimizing future iterations of machine learning module 230. For example, server 120 may continuously traverse one or more of CRM 130, public information database 140, firmographics database 150, install base module 170, and/or digital footprint database 160 in order to ascertain the plurality of target variables. One of the important uses behind the target variables is that they may be used as a metric for effectiveness of the recommendations generated by stacked model 380 due to the fact that target variables may account for factors such as whether the user acted on the recommendation or whether the sale associated with the recommendation was completed. In addition to the target variables being mapped to each other, the target variables are configured to be utilized to establish one or more correlations between the need/demand of the prospect and the product/service in which the target variables may relate to predicted values of machine learning module 230. In some embodiments, the plurality of target variables may be a prediction/output of one or more of the machine learned models of machine learning module 230. It should be noted that target variables may be received and/or identified by server 120 via any applicable manner known to those of ordinary skill in the art including but not limited to ingesting text corpuses (natural language processing), machine learning-based extraction, or any other applicable manner. For example, collection of the target variables may be accomplished in a variety of manners including but not limited to natural language processing of corpus (e.g., social media posts, SEC filings, financial documents, etc.), image recognition within content (e.g., pdf reports/quadrants, social media content, etc.), and voice-to-text processing of audio-based sources.

At step 430 of process 400, server 120 detects/determines a convergence of at least two target variables of the plurality of target variables. It should be noted that a value associated with the convergence may be ascertained based on a threshold defined via server 120, machine learning module 230, the user, or any other applicable mechanism configured to detect that two or more variable targets have intersected. In some embodiments, the determination of the convergence includes server 120 acquiring data derived from supplemental databases 330 and 340, and merging two or more of first machine learned model 310, second machine learned model 320, first deep learning model 350, and/or second deep learning model 360 into stacked model 380 based on data derived from one or more of the plurality of target variables, supplemental databases 330 and 340, the web crawlers, or any other data ascertainable by server 120. One of the purposes of merging two machine learned models is to insert the respective outputs of the models being merged into the stacked model. This merging provides not only an unconventional utilization of multiple target variables and multiple data sources of different types rendering stacked model 380 data agnostic, but also the utilization of various algorithms that may be model specific due to the novel transformation of data that maps target variables at both the data layer and the output layer.

At step 440 of process 400, stacked model 380 generates recommendation output 390 associated with the B2B party based on the convergence. Recommendation output 390 is configured to not only be presented to the user via the centralized platform hosted by server 120 on a user interface, but also recommendation output 390 may be transmitted to CRM 130 in an ingestible format. In some embodiments, recommendation output 390 may include a natural language explanation pertaining to the plurality of target variables (e.g., correlation) in addition to the predicted likelihood that the prospect will purchase the product/service from the user. In some embodiments, recommendation output 390 is generated by stacked model 380 based on two separate types of inputs. For example, one input into stacked model 380 may be data aligned predictions of machine learned models 310 and 320 along with predictions of deep learning models 350 and 360, and the other input into stacked model 380 may be ascertained feature importance values and data aligned model explanations derived from one or more of the aforementioned models. In some embodiments, recommendation output 390 may include a detailed explanation highlighting the relationship between the target variables.

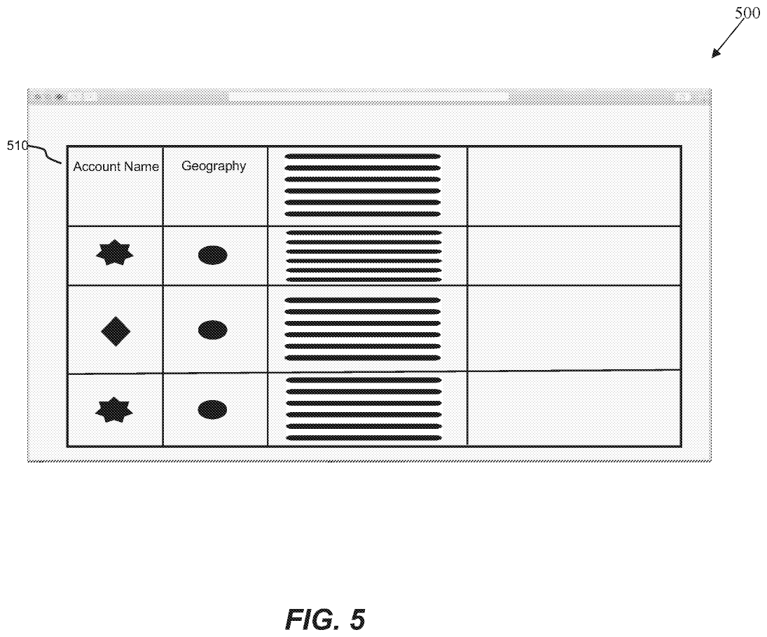

Referring now to FIG. 5, depicts a user interface 500 including the recommendation output in accordance with an exemplary embodiment. In some embodiments, the recommendation output is depicted on the centralized platform and includes a plurality of descriptive fields 510 associated with the recommendation for the product/service. The plurality of descriptive fields may pertain to but is not limited to the account name of prospect, applicable industry, geographic location, market, CMR number of CMR 130, sub-industry, client health (e.g., prospect rapport), or any other applicable descriptive data pertaining to the prospect and/or recommendation output 390 known to those of ordinary skill in the art. In a preferred embodiment, recommendation output 390 is presented in a natural language configured to be received/ingested by CRM 130 or any other applicable CRM software including but not limited to Salesforce, Pipedrive, Zoho, Bitrix24, Nimble, or any other applicable CRM software known to those of ordinary skill in the art. Recommendation output 390 may also be ingested by industry/business intelligent software systems. In some embodiments, recommendation output 390 is depicted in other manners such as a text message, e-mail, and/or directed/customized advertisement presented in designated spots within web-browser content.

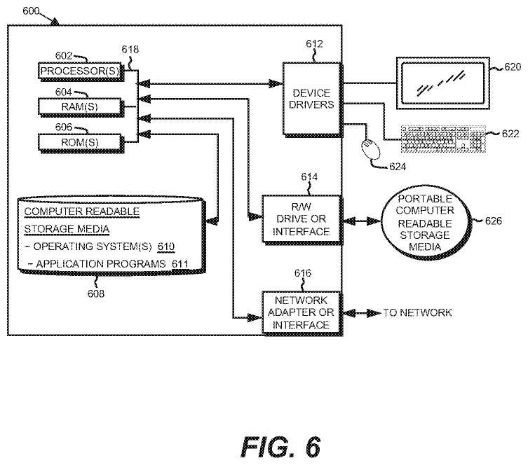

FIG. 6 is a block diagram of components 600 of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 602, 604 is representative of any electronic device capable of executing machine-readable program instructions. Data processing system 602, 604 may be representative of a smart phone, a computer system, PDA, or other electronic devices. Examples of computing systems, environments, and/or configurations that may represented by data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The one or more servers may include respective sets of components illustrated in FIG. 6. Each of the sets of components include one or more processors 602, one or more computer-readable RAMs 608 and one or more computer-readable ROMs 610 on one or more buses 602, and one or more operating systems 614 and one or more computer-readable tangible storage devices 616. The one or more operating systems 614 and computing event management system 210 may be stored on one or more computer-readable tangible storage devices 616 for execution by one or more processors 602 via one or more RAMs 608 (which typically include cache memory). In the embodiment illustrated in FIG. 6, each of the computer-readable tangible storage devices 616 is a magnetic disk storage device of an internal hard drive. Alternatively, each of the computer-readable tangible storage devices 616 is a semiconductor storage device such as ROM 610, EPROM, flash memory or any other computer-readable tangible storage device that can store a computer program and digital information.

Each set of components 600 also includes a R/W drive or interface 614 to read from and write to one or more portable computer-readable tangible storage devices 608 such as a CD-ROM, DVD, memory stick, magnetic tape, magnetic disk, optical disk or semiconductor storage device. A software program, such as computing event management system 210 can be stored on one or more of the respective portable computer-readable tangible storage devices 608, read via the respective RAY drive or interface 618 and loaded into the respective hard drive.

Each set of components 600 may also include network adapters (or switch port cards) or interfaces 616 such as a TCP/IP adapter cards, wireless wi-fi interface cards, or 3G or 4G wireless interface cards or other wired or wireless communication links. COP 120 can be downloaded from an external computer (e.g., server) via a network (for example, the Internet, a local area network or other, wide area network) and respective network adapters or interfaces 616. From the network adapters (or switch port adaptors) or interfaces 616, computing event management system 210 is loaded into the respective hard drive 608. The network may comprise copper wires, optical fibers, wireless transmission, routers, firewalls, switches, gateway computers and/or edge servers.

Each of components 600 can include a computer display monitor 620, a keyboard 622, and a computer mouse 624. Components 600 can also include touch screens, virtual keyboards, touch pads, pointing devices, and other human interface devices. Each of the sets of components 600 also includes device processors 602 to interface to computer display monitor 620, keyboard 622 and computer mouse 624. The device drivers 612, R/W drive or interface 618 and network adapter or interface 618 comprise hardware and software (stored in storage device 604 and/or ROM 606).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

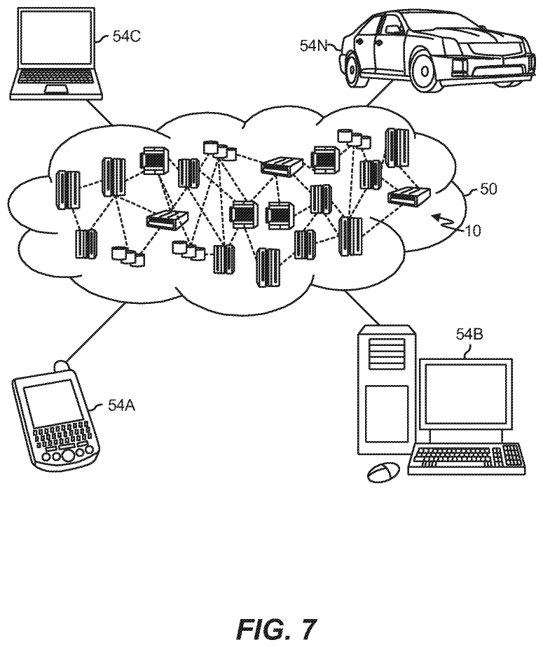

Referring now to FIG. 7, illustrative cloud computing environment 700 is depicted. As shown, cloud computing environment 700 comprises one or more cloud computing nodes 7000 with which local computing devices used by cloud consumers, such as, for example, personal digital assistant (PDA) or cellular telephone 7000A, desktop computer 7000B, laptop computer 7000C, and/or automobile computer system 7000N may communicate. Nodes 7000 may communicate with one another. They may be grouped (not shown) physically or virtually, in one or more networks, such as Private, Community, Public, or Hybrid clouds as described hereinabove, or a combination thereof. This allows cloud computing environment 7000 to offer infrastructure, platforms and/or software as services for which a cloud consumer does not need to maintain resources on a local computing device. It is understood that the types of computing devices 7000A-N shown in FIG. 7 are intended to be illustrative only and that computing nodes 7000 and cloud computing environment 700 can communicate with any type of computerized device over any type of network and/or network addressable connection (e.g., using a web browser).

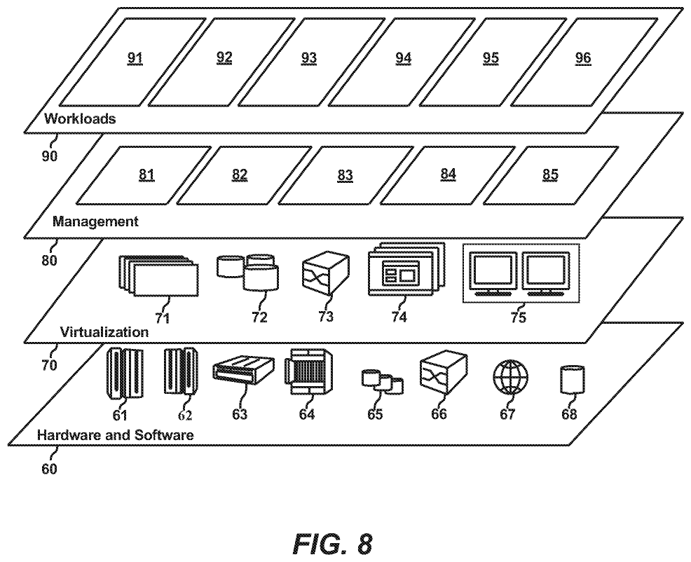

Referring now to FIG. 8 a set of functional abstraction layers provided by cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for automatically generating product recommendations, the method comprising:
receiving, via a computing device, a first dataset pertaining to a territory plan associated with a user and a second dataset pertaining to prospective-based data;
detecting, via the computing device, a plurality of target variables associated with the B2B party within the first and second datasets;
determining, via the computing device, a convergence of at least two target variables of the plurality of target variables; and
generating, via the computing device, a product recommendation associated with the B2B party based on the convergence.

2. The computer-implemented method of claim 1, wherein detecting the plurality of target variables comprises:
generating, via a first machine learned model trained based on the first dataset, a first machine learning model output pertaining to a demand associated with the B2B party; and
generating, via a second machine learned model trained based on the second dataset, a second machine learning model output pertaining to a product or service associated with the demand.

3. The computer-implemented method of claim 2, wherein determining the convergence comprises:
acquiring, via the computing device, a plurality of supplemental data;
merging, via the computing device, the first machine learned model and the second machine learned model into a stacked model based on at least the plurality of supplemental data; and
inserting, via the computing device, the first and second outputs into the stacked model.

4. The computer-implemented method of claim 3, wherein determining the convergence further comprises:
mapping, via the computing device, the two target variables of the plurality of target variables based on the merger; and
generating, via the computing device, the recommendation wherein the recommendation is an output of the stacked model.

5. The computer-implemented method of claim 3, wherein the stacked model is data-agnostic.

6. The computer-implemented method of claim 1, wherein the recommendation includes a detailed explanation pertaining to one or more demands associated with the B2B party.

7. The computer-implemented method of claim 1, wherein the first dataset comprises a plurality of intent indicators associated with the B2B party and the second dataset comprises data pertaining to a plurality of services or products associated with the B2B party.

8. A computer system for automatically generating product recommendations, the computer system comprising:
one or more processors, one or more computer-readable memories, and program instructions stored on at least one of the one or more computer-readable memories for execution by at least one of the one or more processors to cause the computer system to:
program instructions to receive a first dataset pertaining to a territory plan associated with a user and a second dataset pertaining to prospective-based data;
program instructions to detect a plurality of target variables associated with the B2B party within the first and second datasets;
program instructions to determine a convergence of at least two target variables of the plurality of target variables; and
program instructions to generate a product recommendation associated with the B2B party based on the convergence.

9. The computer system of claim 8, wherein the program instructions to detect the plurality of target variables comprises program instructions to:
generate, via a first machine learned model trained based on the first dataset, a first machine learning model output pertaining to a demand associated with the B2B party; and
generate, via a second machine learned model trained based on the second dataset, a second machine learning model output pertaining to a product or service associated with the demand.

10. The computer system of claim 8, wherein the program instructions to determine the convergence comprises program instructions to:
acquire a plurality of supplemental data;
merge the first machine learned model and the second machine learned model into a stacked model based on at least the plurality of supplemental data; and
insert the first and second outputs into the stacked model.

11. The computer system of claim 10, wherein the program instructions to determine the convergence further comprises:
map the two target variables of the plurality of target variables based on the merger; and
generate the recommendation wherein the recommendation is an output of the stacked model.

12. The computer system of claim 10, wherein the program instructions to determine the convergence further comprises:
map the two target variables of the plurality of target variables based on the merger; and
generate the recommendation wherein the recommendation is an output of the stacked model.

13. The computer system of claim 10, wherein the first dataset comprises a plurality of intent indicators associated with the B2B party and the second dataset comprises data pertaining to a plurality of services or products available to the B2B party.

14. A computer program product using a computing device for automatically generating product recommendations, the computer program product comprising:
one or more non-transitory computer-readable storage media and program instructions stored on the one or more non-transitory computer-readable storage media, the program instructions, when executed by the computing device, cause the computing device to perform a method comprising:
receiving, via a computing device, a first dataset pertaining to a territory plan associated with a user and a second dataset pertaining to prospective-based data;
detecting, via the computing device, a plurality of target variables associated with the B2B party within the first and second datasets;
determining, via the computing device, a convergence of at least two target variables of the plurality of target variables; and
generating, via the computing device, a product recommendation associated with the B2B party based on the convergence.

15. The computer program product of claim 14, wherein detecting the plurality of target variables by the computing device comprises:
generating, via a first machine learned model trained based on the first dataset, a first machine learning model output pertaining to a demand associated with the B2B party; and
generating, via a second machine learned model trained based on the second dataset, a second machine learning model output pertaining to a product or service associated with the demand.

16. The computer program product of claim 14, wherein determining the convergence by the computing device comprises:
acquiring, via the computing device, a plurality of supplemental data;
merging, via the computing device, the first machine learned model and the second machine learned model into a stacked model based on at least the plurality of supplemental data; and
inserting, via the computing device, the first and second outputs into the stacked model.

17. The computer program product of claim 16, wherein determining the convergence by the computing device further comprises:
mapping, via the computing device, the two target variables of the plurality of target variables based on the merger; and
generating, via the computing device, the recommendation wherein the recommendation is an output of the stacked model.

18. The computer program product of claim 16, wherein the stacked model is data-agnostic.

19. The computer program product of claim 14, wherein the recommendation includes a detailed explanation pertaining to one or more demands associated with the B2B party.

20. The computer program product of claim 14, wherein the first dataset comprises a plurality of intent indicators associated with the B2B party and the second dataset comprises data pertaining to a plurality of services or products associated with the B2B party.
